(19) United States
(12) Patent Application Publication
(10) Pub. No.: US 2026/0269248 A1
(43) Pub. Date: Sep. 10, 2026

(54) ELECTRODE SHEET AND MANUFACTURING METHOD OF ELECTRODE SHEET

(71) Applicant: TOYOTA JIDOSHA KABUSHIKI KAISHA, Toyota-shi (JP)

(72) Inventor: Masashi UEDA, Toyota-shi (JP)

(21) Appl. No.: 19/459,275

(22) Filed: Jan. 26, 2026

(30) Foreign Application Priority Data
Mar. 5, 2025 (JP) 2025-034680

(51) Int. Cl. H01M 4/583; H01M 4/02; H01M 4/04; H01M 4/1393; H01M 4/62

(52) U.S. Cl. CPC H01M 4/583; H01M 4/0404; H01M 4/0435; H01M 4/1393; H01M 4/623; H01M 2004/021; H01M 2004/027

(57) ABSTRACT

The electrode sheet includes a first electrode composite layer and a second electrode composite layer disposed on the first electrode composite layer. Each of the first electrode composite layer and the second electrode composite layer includes at least active material particles and a binder. A composition of the first electrode composite layer is the same as a composition of the second electrode composite layer. A density of the first electrode composite layer is different from a density of the second electrode composite layer.

### CROSS-REFERENCE TO RELATED APPLICATION

This application claims priority to Japanese Patent Application No. 2025-034680 filed on Mar. 5, 2025. The disclosure of the above-identified application, including the specification, drawings, and claims, is incorporated by reference herein in its entirety.

### BACKGROUND

### 1. Technical Field

The technology disclosed in the present specification relates to an electrode sheet and a manufacturing method of an electrode sheet. 2. Description of Related Art

Japanese Unexamined Patent Application Publication No. 2007-179864 (JP 2007-179864 A) discloses an electrode sheet. The electrode sheet includes a first electrode composite layer and a second electrode composite layer disposed on the first electrode composite layer. Each of the first electrode composite layer and the second electrode composite layer includes active material particles and a binder.

### SUMMARY

In the electrode sheet, the active material particles included in the first electrode composite layer are different from the active material particles included in the second electrode composite layer. That is, a composition of the first electrode composite layer is different from a composition of the second electrode composite layer. As described above, in the electrode sheet, characteristics of the electrode sheet can be improved by laminating a plurality of electrode composite layers having different compositions, but the manufacturing cost of the electrode sheet is increased.

In view of the above circumstances, the present specification provides a technology for improving the characteristics of the electrode sheet without changing the composition of the electrode composite layer.

The technology disclosed in the present specification is embodied in an electrode sheet. According to a first aspect, an electrode sheet includes
a first electrode composite layer, and
a second electrode composite layer disposed on the first electrode composite layer.

Each of the first electrode composite layer and the second electrode composite layer includes at least active material particles and a binder.

A composition of the first electrode composite layer is the same as a composition of the second electrode composite layer.

A density of the first electrode composite layer is different from a density of the second electrode composite layer.

Here, the same composition means that the components contained and a ratio of the weight thereof are the same.

In this configuration, the composition of the first electrode composite layer is the same as the composition of the second electrode composite layer, but the density of the first electrode composite layer is different from the density of the second electrode composite layer. In the electrode composite layer having a high density, the active material particles are close to each other and are strongly bonded by the binder. Accordingly, the electrode composite layer having a high density has a relatively high mechanical strength, and thus the mechanical strength of the electrode sheet is also improved. On the other hand, in the electrode composite layer having a low density, porosity is large. Therefore, an electrolytic solution easily permeates into the electrode composite layer, and ion transport resistance is reduced, so that electrical resistance in the electrode composite layer is reduced. As described above, according to the present technology, both mechanical strength and conductivity in the electrode sheet can be achieved without changing the composition of the electrode composite layer.

According to a second aspect, in the first aspect, the electrode sheet may further include a current collector having a surface on which the first electrode composite layer is disposed. In this case, the density of the first electrode composite layer may be higher than the density of the second electrode composite layer. According to such a configuration, in the second electrode composite layer located on the surface layer side (that is, on the side opposite to the current collector) of the electrode sheet among the first electrode composite layer and the second electrode composite layer, the porosity can be made relatively large. The ion transport resistance in the electrode composite layer is further reduced, and the electrical resistance in the electrode composite layer can be further reduced.

According to a third aspect, in the first or second aspect, the electrode sheet may be a negative electrode sheet. In this case, the density of the first electrode composite layer may be 1.35 g/cm³ or more.

The technology disclosed in the present specification is also embodied in a manufacturing method of an electrode sheet. That is, according to a fourth aspect, a manufacturing method of an electrode sheet includes
preparing an electrode composite mixture by mixing at least active material particles and a binder,
preparing a first electrode composite sheet by rolling a part of the electrode composite mixture with a pair of rollers,
preparing a second electrode composite sheet by rolling another part of the electrode composite mixture with the rollers, and
preparing a multilayer-structured electrode composite sheet by laminating the first electrode composite sheet and the second electrode composite sheet.

A speed ratio between the rollers in the preparing the first electrode composite sheet is different from a speed ratio between the rollers in the preparing the second electrode composite sheet.

In a case where the speed ratio between the rollers is changed when the first electrode composite sheet is prepared by rolling, a density of the first electrode composite sheet to be prepared changes. The same applies to the second electrode composite sheet. Based on this finding, in the manufacturing method, the speed ratio between the rollers is different between the preparing the first electrode composite sheet and the preparing the second electrode composite sheet. As a result, the first electrode composite sheet and the second electrode composite sheet having different densities can be prepared from the electrode composite mixture having the same composition. Then, by laminating the two electrode composite sheets, the multilayer-structured electrode composite sheet that constitutes a part or all of the electrode sheet according to the present technology can be prepared.

According to a fifth aspect, in the fourth aspect, the manufacturing method may further include laminating the multilayer-structured electrode composite sheet and a current collector in an arrangement in which the first electrode composite sheet is in contact with the current collector. In this case, the speed ratio between the rollers in the preparing the first electrode composite sheet may be smaller than the speed ratio between the rollers in the preparing the second electrode composite sheet. According to such a configuration, the density of the first electrode composite sheet can be made higher than the density of the second electrode composite sheet. Accordingly, the manufacturing method of the present aspect can be adopted, for example, to manufacture the electrode sheet of the second aspect described above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of an electrode sheet 10;

FIG. 2 is a diagram for describing the configuration of the electrode sheet 10;

FIG. 3 shows a relationship between a density of a first electrode composite layer 16 and a tensile strength of the first electrode composite layer 16;

FIG. 4 shows the density of the first electrode composite layer 16 in a multilayer electrode composite layer 14 and a change in a tensile strength of the multilayer electrode composite layer 14, note that the density of the second electrode composite layer 18 is constant;

FIG. 5 is a flowchart for describing a manufacturing method of the electrode sheet 10;

FIG. 6 is a diagram for describing a step of preparing an electrode composite mixture 26 by mixing two binders 22, 24 with active material particles 20 using a mixer 100;

FIG. 7 is a diagram for describing a step of preparing a first electrode composite sheet 16A by rolling a part of the electrode composite mixture 26 using a roll press device 106;

FIG. 8 is a diagram for describing a step of preparing a multilayer-structured electrode composite sheet 14A by integrating the first electrode composite sheet 16A and a second electrode composite sheet 18A using a flat plate press device 110; and

FIG. 9 shows a relationship between a speed ratio between a pair of rollers 108 and a density of the first electrode composite sheet 16A.

### DETAILED DESCRIPTION OF EMBODIMENTS

The electrode sheet 10 of the embodiment will be described with reference to the drawings. The electrode sheet 10 of the embodiment is used as, for example, a negative electrode of a lithium ion secondary battery.

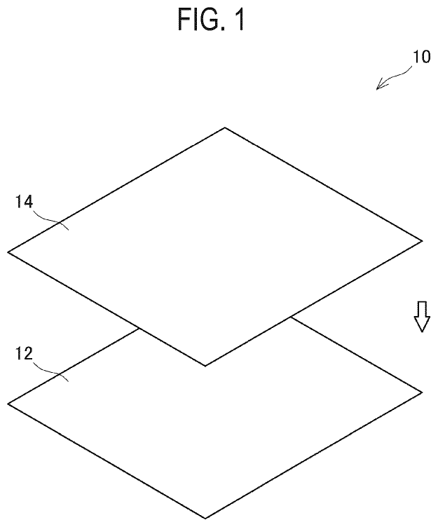

As shown in FIG. 1, the electrode sheet 10 includes a current collector 12 and a multilayer electrode composite layer 14. The current collector 12 is a conductive sheet. The current collector 12 is, for example, a copper foil or an aluminum foil. A thickness of the current collector 12 is, for example, 5 μm or more and 50 μm or less. The multilayer electrode composite layer 14 is disposed on a surface of the current collector 12. A thickness of the multilayer electrode composite layer 14 is, for example, 10 μm or more and 500 μm or less.

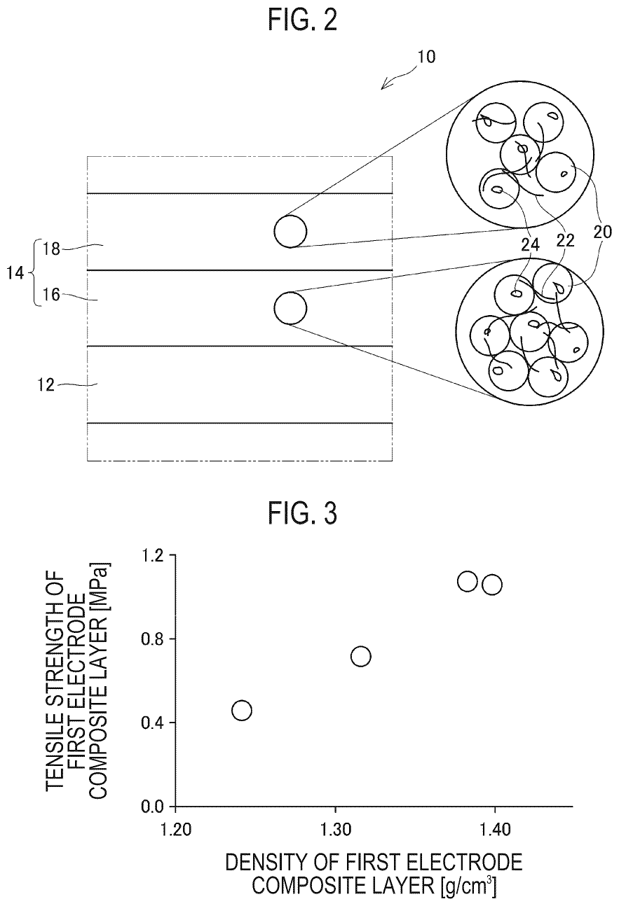

As shown in FIG. 2, the multilayer electrode composite layer 14 includes a first electrode composite layer 16 and a second electrode composite layer 18. The first electrode composite layer 16 is disposed on the current collector 12. The second electrode composite layer 18 is disposed on the first electrode composite layer 16. A ratio of a thickness of the first electrode composite layer 16 to a thickness of the second electrode composite layer 18 is not particularly limited, but may be, for example, in a range of 30:70 to 70:30.

Each of the first electrode composite layer 16 and the second electrode composite layer 18 includes active material particles 20 and two binders 22, 24. As described above, since the electrode sheet 10 of the present embodiment is used as a negative electrode of a lithium ion secondary battery, the active material particles 20 are negative electrode active material particles. Examples of the active material particles 20 include a carbon material such as graphite, hard carbon, or soft carbon; a material that alloys with lithium, such as silicon (Si); and a lithium alloy of these materials (for example, Li_{X}M, where M is C, Si, Sn, Sb, Al, Mg, Ti, Bi, Ge, Pb, or P, and X is a natural number). The active material particles 20 may be composed of a single kind of material or may be composed of multiple kinds of materials. An average particle diameter of the active material particles 20 is not particularly limited, but is, for example, 5 μm or more and 50 μm or less. The average particle diameter here means a particle diameter (D50) at a cumulative value of 50% in a volume-based particle size distribution measured by a laser diffraction and scattering method.

The two binders 22, 24 can bind the active material particles 20 to each other. The two binders 22, 24 include a first binder 22 and a second binder 24. Examples of each of the binders 22, 24 include carboxymethyl cellulose (CMC), styrene butadiene rubber (SBR), polyvinylidene fluoride (PVdF), polytetrafluoroethylene (PTFE), polyacrylic acid (PAA), an acrylic resin, ultra-high molecular weight polyethylene, or the like. Each of the binders 22, 24 may be composed of a single kind of material or may be composed of multiple kinds of materials.

In the present embodiment, the first binder 22 is a resin that can be easily fibrillated. Therefore, in the electrode sheet 10, the first binder 22 is fibrillated. The resin that can be fibrillated here means a resin that can be fibrillated by applying a shear force. Examples of the resin that can be fibrillated include cellulose, an acrylic resin, ultra-high molecular weight polyethylene, and PTFE. However, each of the first electrode composite layer 16 and the second electrode composite layer 18 does not necessarily need to include two binders 22, 24. In another embodiment, each of the first electrode composite layer 16 and the second electrode composite layer 18 may include one binder or may include three or more binders. However, from the viewpoint of preparing the electrode sheet 10 by a dry process described below, each of the first electrode composite layer 16 and the second electrode composite layer 18 may include a resin that can be easily fibrillated as the binder. Here, a technology related to the fibrillation of the binder is described in, for example, US 2019/0237748 A.

Each of the first electrode composite layer 16 and the second electrode composite layer 18 may further include a conductive auxiliary agent or the like.

The composition of the first electrode composite layer 16 is the same as the composition of the second electrode composite layer 18. Here, the same composition means that the components contained and a ratio of the weight thereof are the same. In addition, the density of the first electrode composite layer 16 is different from the density of the second electrode composite layer 18. In the present embodiment, the density of the first electrode composite layer 16 is larger than the density of the second electrode composite layer 18. The density of the first electrode composite layer 16 is, for example, 1.35 g/cm³ or more.

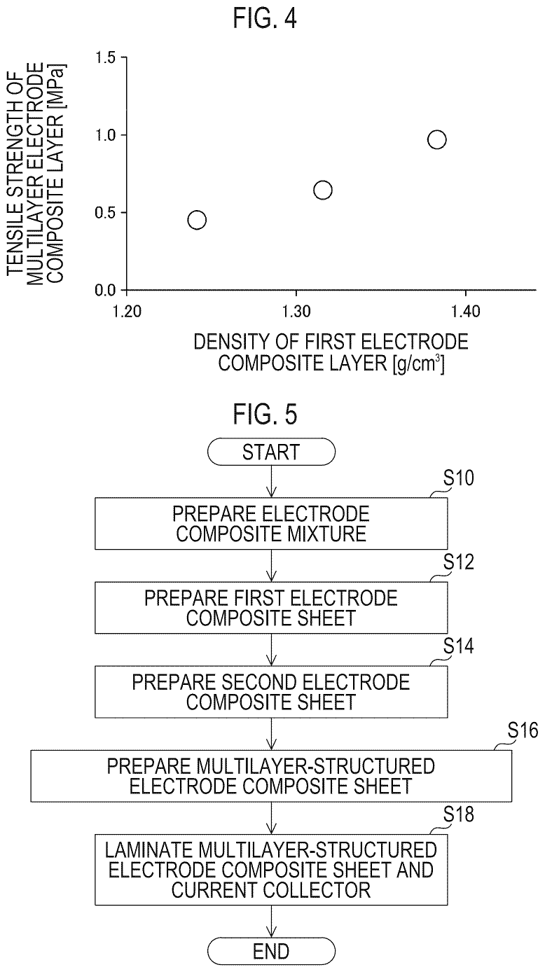

In the electrode sheet 10, the composition of the first electrode composite layer 16 is the same as the composition of the second electrode composite layer 18, but the density of the first electrode composite layer 16 is different from the density of the second electrode composite layer 18. In the first electrode composite layer 16 having a large density, the active material particles 20 are close to each other and are strongly bonded to each other by the binders 22, 24. Accordingly, the first electrode composite layer 16 having a large density has a relatively high mechanical strength, and thus the mechanical strength of the electrode sheet 10 is also improved. Regarding this point, the inventors of the present disclosure investigated a relationship between the density and the tensile strength of the electrode composite layer in a case where the first electrode composite layer 16 and/or the second electrode composite layer 18 includes graphite as the active material particles 20, PTFE as the first binder 22, and PVdF as the second binder 24 at a weight ratio of 94.5:3.0:2.5. As shown in FIG. 3, it was confirmed that, as the density of the first electrode composite layer 16 increases, the tensile strength of the first electrode composite layer 16 increases. In particular, in a case where the density of the first electrode composite layer 16 is 1.35 g/cm³ or more, the tensile strength of the first electrode composite layer 16 is relatively high. In addition, as shown in FIG. 4, it was confirmed that, as the density of the first electrode composite layer 16 in the multilayer electrode composite layer 14 increases, the tensile strength of the multilayer electrode composite layer 14 increases. The density of the second electrode composite layer 18 of the multilayer electrode composite layer 14 was constant (1.24 g/cm³). On the other hand, in the second electrode composite layer 18 having a small density, the porosity is large. Therefore, the electrolytic solution easily permeates into the second electrode composite layer 18, and the ion transport resistance is reduced, so that the electrical resistance in the second electrode composite layer 18 is reduced. As described above, according to the present technology, it is possible to achieve both mechanical strength and conductivity in the electrode sheet 10 without changing the composition of the electrode composite layers 16, 18.

The electrode sheet 10 in the present embodiment includes the current collector 12 on which the first electrode composite layer 16 is disposed on a surface thereof. In this case, the density of the first electrode composite layer 16 is larger than the density of the second electrode composite layer 18. According to such a configuration, in the second electrode composite layer 18 located on the surface layer side (that is, on a side opposite to the current collector) of the electrode sheet 10 among the first electrode composite layer 16 and the second electrode composite layer 18, the porosity can be made relatively large. The ion transport resistance in the multilayer electrode composite layer 14 is further reduced, and the electrical resistance in the multilayer electrode composite layer 14 can be further reduced.

Next, the manufacturing method of the electrode sheet 10 will be described with reference to FIGS. 5 to 8. In this manufacturing method, the electrode sheet 10 can be prepared without using a solvent. That is, the manufacturing method is a so-called dry process.

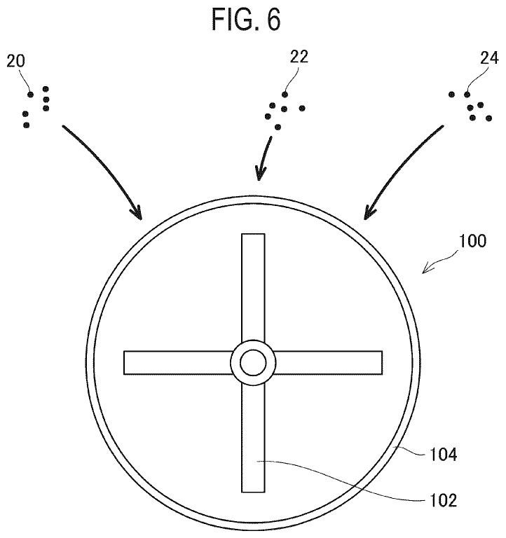

As shown in FIG. 5, the manufacturing method includes a step (S10) of preparing the electrode composite mixture 26 by mixing the two binders 22, 24 with the active material particles 20. In this step, for example, as shown in FIG. 6, a mixer 100 is used. The mixer 100 rotates a blade 102 to mix the active material particles 20 and the two binders 22, 24, which are put into a container 104. As a result, the electrode composite mixture 26 is prepared.

As a specific example, in the step S10, graphite (average particle diameter: 10 pm), PTFE (manufactured by KEMAR), and PVdF (manufactured by Arkema) may be put into a mixer (MP5B, manufactured by Nippon Cokes & Engineering Co., Ltd.), mixed at 300 rpm for 180 seconds, and then mixed at 3000 rpm for 8 minutes. Here, the graphite is an example of the active material particles 20, the PTFE is an example of the first binder 22, and the PVdF is an example of the second binder 24. A weight ratio of the graphite: PTFE: PVdF may be 94.5:3.0:2.5.

As described above, in the present embodiment, the mixer 100 increases the rotation speed of the blade 102 in stages and mixes the active material particles 20 and the two binders 22, 24 at two different rotation speeds. However, the mixer 100 does not necessarily increase the rotation speed of the blade 102 in two stages. As another embodiment, the rotation speed of the blade 102 may be constant or may be increased in three or more stages. In addition, in S10, the mixer 100 does not necessarily need to be used. In another embodiment, another mixing machine such as a blender or a mill may be used instead of the mixer 100.

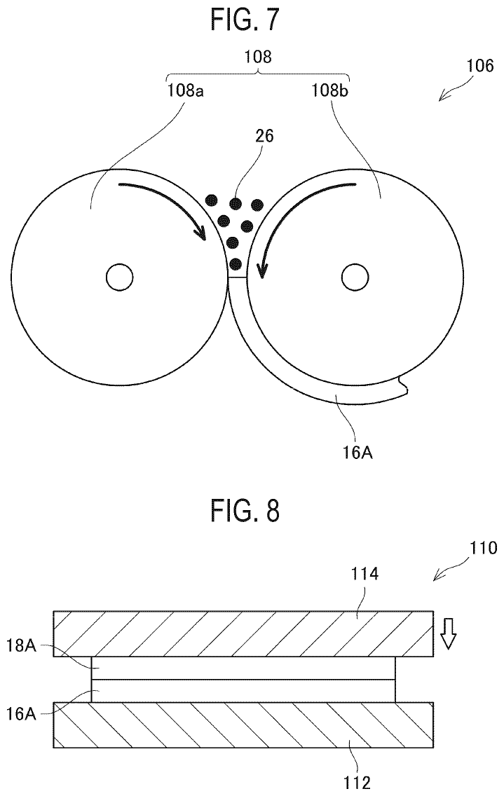

As shown in FIG. 5, the manufacturing method further includes a step (S12) of preparing the first electrode composite sheet 16A by rolling a part of the electrode composite mixture 26. In this step, for example, as shown in FIG. 7, a roll press device 106 is used. The roll press device 106 includes a pair of rollers 108. A part of the electrode composite mixture 26 is rolled by the rollers 108 while passing between the rollers 108. As a specific example, in the step S12, a part of the electrode composite mixture 26 may be rolled by a roll press device (SA-602, manufactured by Tester Industry Co., Ltd.). As a result, the first electrode composite sheet 16A is prepared.

As shown in FIG. 5, the manufacturing method further includes a step (S14) of preparing the second electrode composite sheet 18A by rolling another part of the electrode composite mixture 26. In this step, the roll press device 106 used in S12 is used. Another part of the electrode composite mixture 26 is rolled by the rollers 108 while passing between the rollers 108. As a specific example, in the step S14, another part of the electrode composite mixture 26 may be rolled by a roll press device (SA-602, manufactured by Tester Industry Co., Ltd.). As a result, the second electrode composite sheet 18A is prepared.

In the roll press device 106, one roller 108a of the rollers 108 is configured to be rotatable at a speed different from that of the other roller 108b of the rollers 108. A rotation speed of the one roller 108a of the rollers 108 is slower than a rotation speed of the other roller 108b of the rollers 108. In the present specification, a ratio of the rotation speed of the other roller 108b of the rollers 108 to the rotation speed of the one roller 108a of the rollers 108 may be referred to as a speed ratio between the rollers 108. A speed ratio between the rollers 108 in the step (S12) of preparing the first electrode composite sheet 16A is different from a speed ratio between the rollers 108 in the step (S14) of preparing the second electrode composite sheet 18A. In the present embodiment, the speed ratio between the rollers 108 in the step (S12) of preparing the first electrode composite sheet 16A is smaller than the speed ratio between the rollers 108 in the step (S14) of preparing the second electrode composite sheet 18A. The speed ratio between the rollers 108 in the step of preparing the first electrode composite sheet 16A is, for example, 1.1 or less.

As shown in FIG. 5, the manufacturing method further includes a step (S16) of preparing the multilayer-structured electrode composite sheet 14A by laminating the first electrode composite sheet 16A and the second electrode composite sheet 18A. In this step, for example, as shown in FIG. 8, a flat plate press device 110 is used. The flat plate press device 110 includes a stage 112 and an upper die 114. The upper die 114 is lowered in a state where the first electrode composite sheet 16A and the second electrode composite sheet 18A are laminated on the stage 112 in this order. As a specific example, in the step S16, the first electrode composite sheet 16A and the second electrode composite sheet 18A may be pressurized at a surface pressure of 0.2 t/cm² by a flat plate press device (manufactured by AS ONE Corporation, model number H300-05). As a result, the multilayer-structured electrode composite sheet 14A is prepared. In the step S16, a roll press device (SA-602, manufactured by Tester Industry Co., Ltd.) may be used instead of the flat plate press device. In this case, another part of the electrode composite mixture 26 may be rolled at a linear pressure of 0.4 t/cm by a roll press device (SA-602, manufactured by Tester Industry Co., Ltd.).

As shown in FIG. 5, the manufacturing method further includes a step (S18) of laminating the multilayer-structured electrode composite sheet 14A and the current collector 12 such that the first electrode composite sheet 16A is in contact with the current collector 12. In this step, for example, as shown in FIG. 8, a flat plate press device is used. The upper die of the flat plate press device is lowered in a state where the multilayer-structured electrode composite sheet 14A and the current collector 12 are laminated on the stage of the flat plate press device, such that the first electrode composite sheet 16A is in contact with the current collector 12. As a result, the multilayer-structured electrode composite sheet 14A and the current collector 12 are integrated. As a specific example, in the step S18, the multilayer-structured electrode composite sheet 14A and a copper foil having a thickness of 8 μm may be pressurized at a surface pressure of 0.2 t/cm² by a flat plate press device (model number H300-05, manufactured by AS ONE Corporation). Here, the copper foil is an example of the current collector 12.

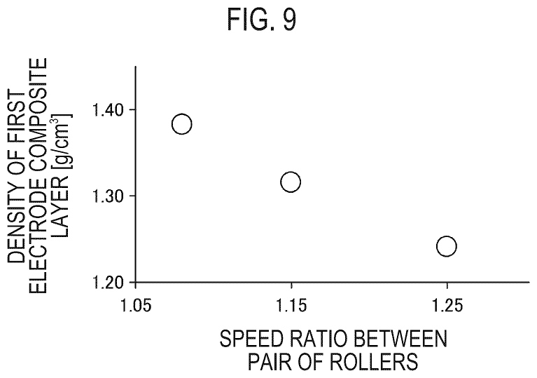

The inventors of the present disclosure confirmed, as shown in FIG. 9, that, in the step (S12) of preparing the first electrode composite sheet 16A, in a case where the speed ratio between the rollers 108 is changed, the density of the first electrode composite sheet 16A to be prepared changes. Specifically, it was confirmed that, in a case where the speed ratio between the rollers 108 is increased, the density of the first electrode composite sheet 16A to be prepared is reduced. In addition, it was confirmed that, in a case where the speed ratio between the rollers 108 is 1.1 or less, the density of the first electrode composite sheet 16A to be prepared is 1.35 g/cm³ or more. The same applies to the second electrode composite sheet 18A. Based on this finding, in the manufacturing method, the speed ratio between the rollers 108 is different between the step (S12) of preparing the first electrode composite sheet 16A and the step (S14) of preparing the second electrode composite sheet 18A. As a result, it is possible to prepare the first electrode composite sheet 16A and the second electrode composite sheet 18A having different densities from the electrode composite mixture 26 having the same composition. As a specific example, in a case where the weight ratio of the active material particles 20: the binder 22 (PTFE): the binder 24 (PVdF) in the electrode composite mixture 26 is 94.5:3.0:2.5, the weight ratio of the active material particles 20: the binder 22 (PTFE): the binder 24 (PVdF) in both the first electrode composite sheet 16A and the second electrode composite sheet 18A is 94.5:3.0:2.5. However, the densities of the first electrode composite sheet 16A and the second electrode composite sheet 18A are different. Then, by laminating the two electrode composite sheets 16A, 18A, it is possible to prepare the multilayer-structured electrode composite sheet 14A that constitutes a part or all of the electrode sheet 10 according to the present technology.

Accordingly, the electrode sheet 10 including the electrode composite layers 16, 18 having the same composition and different densities is manufactured by the manufacturing method. That is, the first electrode composite sheet 16A is the first electrode composite layer 16 shown in FIG. 2. Then, the second electrode composite sheet 18A is the second electrode composite layer 18 shown in FIG. 2. In addition, the multilayer-structured electrode composite sheet 14A is the multilayer electrode composite layer 14 shown in FIGS. 1 and 2.

In addition, in the manufacturing method, the steps (S12 and S14) of preparing the electrode composite sheets 16A, 18A do not include a step of applying a shear stress to the binders 22, 24 by a kneader. That is, a treatment that promotes the fibrillation of the binders 22, 24 is not performed. Therefore, at least one electrode composite layer (for example, the first electrode composite layer 16) included in the multilayer electrode composite layer 14 is densified. As a result, it is possible to improve the tensile strength of the electrode composite layer and the multilayer electrode composite layer 14 including the electrode composite layer without promoting the fibrillation of the binders 22, 24 contained in the electrode composite layer. The binders 22, 24 often do not have conductivity. Therefore, in a case where the binders 22, 24 are fibrillated, for example, the electrical characteristics of the multilayer electrode composite layer 14 may be deteriorated, such as electron conductivity. Regarding this point, as in the manufacturing method of the present embodiment, the fibrillation of the binders 22, 24 is suppressed, so that the deterioration of the electrical characteristics of the multilayer electrode composite layer 14 can be avoided or suppressed.

The manufacturing method of the electrode sheet 10 further includes a step (S18) of laminating the multilayer-structured electrode composite sheet 14A and the current collector 12 such that the first electrode composite sheet 16A is in contact with the current collector 12. In this case, the speed ratio between the rollers 108 in the step (S12) of preparing the first electrode composite sheet 16A is smaller than the speed ratio between the rollers 108 in the step (S14) of preparing the second electrode composite sheet 18A. According to such a configuration, the density of the first electrode composite sheet 16A can be made larger than the density of the second electrode composite sheet 18A. Accordingly, by adopting the manufacturing method, it is possible to manufacture the electrode sheet 10 including the first electrode composite layer 16 having a density larger than the density of the second electrode composite layer 18.

In the embodiment described above, the electrode sheet 10 adopted as the negative electrode of the lithium ion secondary battery was described as an example of the present technology. However, the technology disclosed in the present specification is not limited to the negative electrode of the lithium ion secondary battery, and can also be adopted in an electrode sheet adopted as a positive electrode of the lithium ion secondary battery. In this case, the active material particles 20 described above may be changed to positive electrode active material particles. Examples of the positive electrode active material particles include lithium composite oxides such as a lithium nickel-based composite oxide, a lithium cobalt-based composite oxide, a lithium manganese-based composite oxide, a lithium nickel manganese-based composite oxide, and a lithium nickel manganese cobalt-based composite oxide. In addition, the electrode sheet 10 is not limited to the lithium ion secondary battery, and can be similarly adopted in an electrode sheet (positive electrode or negative electrode) of any type of secondary battery.

The electrode sheet 10 of the present embodiment includes the current collector 12. However, the electrode sheet 10 does not necessarily need to include the current collector 12. That is, as another embodiment, the multilayer electrode composite layer 14 may constitute the electrode sheet 10 alone. In this case, the first electrode composite layer 16 and/or the second electrode composite layer 18 of the multilayer electrode composite layer 14 may be a self-supporting electrode layer. In other words, the first electrode composite sheet 16A and/or the second electrode composite sheet 18A may be a self-supporting electrode sheet. The self-supporting electrode layer (or electrode sheet) here means an electrode layer (or electrode sheet) that is supported by itself without requiring a support such as the current collector 12.

In the electrode sheet 10 of the present embodiment, the density of the first electrode composite layer 16 is larger than the density of the second electrode composite layer 18. However, the density of the first electrode composite layer 16 may be different from the density of the second electrode composite layer 18. That is, in another embodiment, the density of the first electrode composite layer 16 may be smaller than the density of the second electrode composite layer 18.

In other words, in the manufacturing method of the electrode sheet 10 of the present embodiment, the speed ratio between the rollers 108 in the step (S12) of preparing the first electrode composite sheet 16A is smaller than the speed ratio between the rollers 108 in the step (S14) of preparing the second electrode composite sheet 18A. However, these speed ratios may be different. That is, in another embodiment, the speed ratio between the rollers 108 in the step (S12) of preparing the first electrode composite sheet 16A may be larger than the speed ratio between the rollers 108 in the step (S14) of preparing the second electrode composite sheet 18A.

In the embodiment described above, as shown in FIG. 5, in the manufacturing method of the electrode sheet 10, the second electrode composite sheet 18A is prepared (S14) after the first electrode composite sheet 16A is prepared (S12). However, in one modification, the first electrode composite sheet 16A may be prepared after the second electrode composite sheet 18A is prepared. That is, in the manufacturing method of the electrode sheet 10 shown in FIG. 5, S14 may be executed before S12.

The multilayer electrode composite layer 14 of the present embodiment includes two electrode composite layers 16, 18. However, the multilayer electrode composite layer 14 may further include an electrode composite layer as long as it includes two electrode composite layers 16, 18 having the same composition and different densities. The multilayer-structured electrode composite sheet 14A may further include an electrode composite sheet as long as two electrode composite sheets 16A, 18A having the same composition and different densities are laminated. In this case, the first electrode composite layer 16 (or the first electrode composite sheet 16A) may be provided on a surface of the current collector 12.

Although some specific examples have been described in detail above, these are merely examples and do not limit the scope of claims. The technology described in the claims includes various modifications and changes of the specific examples exemplified above. The technical elements described in the present specification or the drawings exhibit their technical usefulness alone or in combination.

What is claimed is:

1. An electrode sheet comprising:
a first electrode composite layer; and
a second electrode composite layer disposed on the first electrode composite layer, wherein:
each of the first electrode composite layer and the second electrode composite layer includes at least active material particles and a binder;
a composition of the first electrode composite layer is the same as a composition of the second electrode composite layer; and
a density of the first electrode composite layer is different from a density of the second electrode composite layer.

2. The electrode sheet according to claim 1, further comprising:
a current collector having a surface on which the first electrode composite layer is disposed,
wherein the density of the first electrode composite layer is higher than the density of the second electrode composite layer.

3. The electrode sheet according to claim 1, wherein:
the electrode sheet is a negative electrode sheet; and
the density of the first electrode composite layer is 1.35 g/cm³ or more.

4. A manufacturing method of an electrode sheet, the manufacturing method comprising:
preparing an electrode composite mixture by mixing at least active material particles and a binder;
preparing a first electrode composite sheet by rolling a part of the electrode composite mixture with a pair of rollers;
preparing a second electrode composite sheet by rolling another part of the electrode composite mixture with the rollers; and
preparing a multilayer-structured electrode composite sheet by laminating the first electrode composite sheet and the second electrode composite sheet,
wherein a speed ratio between the rollers in the preparing the first electrode composite sheet is different from a speed ratio between the rollers in the preparing the second electrode composite sheet.

5. The manufacturing method according to claim 4, further comprising:
laminating the multilayer-structured electrode composite sheet and a current collector in an arrangement in which the first electrode composite sheet is in contact with the current collector,
wherein the speed ratio between the rollers in the preparing the first electrode composite sheet is smaller than the speed ratio between the rollers in the preparing the second electrode composite sheet.
